(19) United States
(12) Patent Application Publication
(10) Pub. No.: US 2018/0170100 A1
(43) Pub. Date: Jun. 21, 2018

(54) Torque Wrench Stabilizer Tool

(71) Applicant: R & M Diesel, Inc., Prague, OK (US)

(72) Inventor: Rob Hardison, Prague, OK (US)

(21) Appl. No.: 15/386,810

(22) Filed: Dec. 21, 2016

(51) Int. Cl. B60B 29/00; B25B 23/00

(52) U.S. Cl. CPC B60B 29/007; B25B 23/00

(57) ABSTRACT

A torque wrench stabilizer tool for supporting a torque wrench assembly is disclosed. The torque wrench assembly is used to engage lug nuts holding a wheel and tire onto a vehicle. The torque wrench stabilizer tool includes a tire clamp and a wrench support boom. The tire clamp is positionable on and temporarily connectable to the top of the tire. The tire clamp has a clamping flange, a boom support flange and a beam. The beam supports the clamping flange and the boom support flange a first distance apart in a tire clamping position. The beam has a first side and a second side opposite the first side. The clamping flange and the boom support flange being positioned on and extending from the first side of the beam. The wrench support boom is configured to be supported by the tire clamp and is sized and dimensioned to extend from the tire clamp in front of the lug nuts. The boom has a first extension support finger positionable adjacent to a first lug nut of the lug nuts, and a second extension support finger positionable adjacent to a second lug nut of the lug nuts.

### BACKGROUND

For large trucks, lug nuts holding a wheel to an axle have to be tightened to 450-500 lbs/foot. This requires a large torque wrench having a relatively long lever arm to achieve the necessary torque. However, the lug nuts are normally recessed within a wheel well and this necessarily entails the use of a wrench extension bar connecting a socket to a ratchet end of the torque wrench. Thus, the socket is spaced quite far from the application of the torque by means of the wrench extension bar connecting the socket to the torque wrench. In using the torque wrenches presently available, the usual procedure, after applying the socket to the lug nut is to attempt to form a support by holding the torque wrench with one hand at its pivot point and turning the torque wrench with the other hand. Quite often the amount of force necessary to tighten or loosen the lug nut is greater than one man can exert with one hand and the combined efforts of two men (one to support the ratchet end of the torque wrench and socket on the lug nut, and the other to turn the wrench) are needed to tighten or loosen the lug nut.

In the past, common methodologies for tightening the lug nut with a single person involve supporting/stabilizing the torque wrench with ad hoc methods, such as placing the ratchet end of the torque wrench on a five gallon bucket, or a jack stand. Needless to say, it is a difficult proposition for a single person to tighten the lug nuts using the prior methodologies.

### BRIEF DESCRIPTION OF SEVERAL VIEWS OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing.

FIG. 1 is a perspective view of a single person operating a torque wrench and tightening a lug nut utilizing an exemplary torque wrench stabilizer tool constructed in accordance with the present disclosure.

FIG. 2 is a perspective view of the torque wrench stabilizer tool positioned in a compact configuration in which a tire clamp and a wrench support boom of the torque wrench stabilizer tool are interlocked and can be easily transported.

FIG. 3 is a perspective view of the torque wrench stabilizer tool in a separated configuration in which the tire clamp and the support boom are not interlocked prior to installation of the torque wrench stabilizer tool onto a tire of a vehicle.

FIG. 4 is a top plan view of an exemplary wrench support boom constructed in accordance with the present disclosure.

FIG. 5 is an end view of the wrench support boom depicted in FIG. 4.

FIG. 6 is a side elevational view of an exemplary boom support flange of the torque wrench stabilizer tool and constructed in accordance with the present disclosure.

FIG. 7 is a side elevational view of an exemplary clamping flange of the torque wrench stabilizer tool and constructed in accordance with the present disclosure.

FIG. 8 is a front elevational view of the torque wrench stabilizer tool being installed onto the tire in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

In one embodiment, the torque wrench stabilizer tool is a way to support/stabilize a torque wrench while the torque wrench is being used to tighten or untighten lug nuts holding a tire on a vehicle. This permits a single person to tighten or untighten the lug nuts. For example, proper operation/maintenance of large trucks require the lug nuts to be tightened to 450-500 lbs/feet. This requires a torque wrench having a large lever arm to achieve the necessary torque. In general, the torque wrench stabilizer tool may have two separate pieces, i.e., a tire clamp that engages and clamps itself to a top of the tire and a wrench support boom that is movably connected to and supported by the tire clamp. When the tire clamp is installed on the tire, the wrench support boom connected to the tire clamp extends in front of the lug nuts and has a variety of wrench extension support fingers that are used to hold a wrench extension bar of the torque wrench while the torque wrench is being used to tighten and/or untighten the lug nuts.

The disclosure is capable of other embodiments or of being practiced or carried out in various ways. For example, although the heavy truck industry may be used as an example, the torque wrench stabilizer tool can be sized and thereby used in a variety of industries such as industries serving consumer vehicles, commercial trucks, tractors, heavy equipment and the like. Also, it is to be understood that the phraseology and terminology employed herein is for purposes of description, and should not be regarded as limiting.

The following detailed description refers to the accompanying drawings. The same reference numbers in different drawings may identify the same or similar elements.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, any reference to “one embodiment,” “an embodiment,” “some embodiments,” “one example,” “for example,” or “an example” means that a particular element, feature, structure or characteristic described in connection with the embodiment is included in at least one embodiment. The appearance of the phrase “in some embodiments” or “one example” in various places in the specification is not necessarily all referring to the same embodiment, for example.

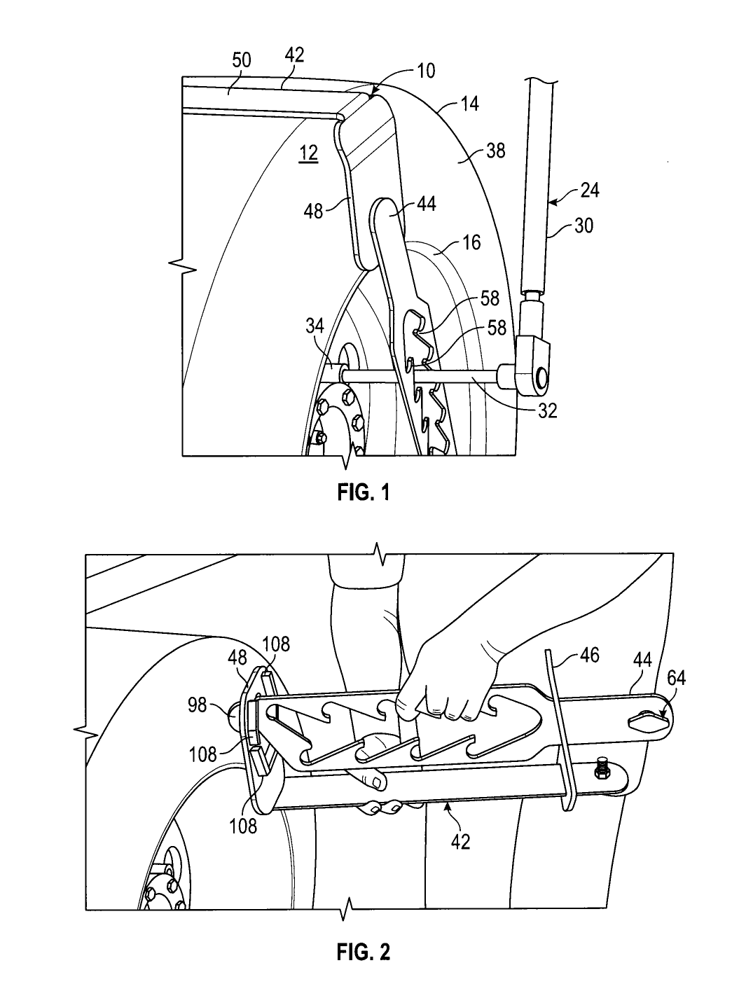

Referring now to the Figures, and in particular to FIG. 1, shown therein and designated by reference numeral 10 is a torque wrench stabilizer tool constructed in accordance with the present disclosure. As shown, the torque wrench stabilizer tool 10 is in a working configuration and connected to a top 12 of a tire 14. The tire 14 is connected to and supported by a wheel 16 that is connected to an axle (not shown) of a vehicle (not shown) using a plurality of lug nuts (not shown). In FIG. 1, a single person is operating a torque wrench assembly 24 and tightening one of the lug nuts utilizing the torque wrench stabilizer tool 10. In this example, the torque wrench assembly 24 is provided with a torque wrench 30, a wrench extension bar 32 connected to the torque wrench 30, and a socket 34 connected to the wrench extension bar 32.

The tire 14 can be designed for use in consumer applications and/or commercial applications. The vehicle can be designed to transport people or goods, especially on land. For example, the vehicle can be a consumer vehicle such as a car, truck or motorcycle; a commercial vehicle such as a semi-truck, semi-trailer, bus or the like; a farm vehicle, such as a tractor, harvester, grain cart or the like; construction vehicle such as a forklift, backhoe, loader, bulldozer or the like; or a home vehicle such as a golf cart, lawn mower, or lawn and garden cart. The tire 14 is designed and configured to be used on the vehicle. In the embodiment shown in FIG. 1, for example, the tire 14 is a commercial truck tire designed to handle heavy loads while provide handling, durability and high mileage life. Commercial truck tires routinely endure long driving times and distance, and have to perform in a variety of conditions, including but not limited to, rain, cold, snow, and heat. The design of the tire 14 (including but not limited to the width) can vary widely and the torque wrench stabilizer tool 10 can be designed and constructed to be used with a variety of different designs of the tire 14. In the example shown, the tire 14 has the top 12, a front surface 38, and a rear surface 40 (see FIG. 8).

The torque wrench stabilizer tool 10 is provided with a tire clamp 42, and a wrench support boom 44. The tire clamp 42 is positionable on and temporarily connectable to the top 12 of the tire 14. The tire clamp 42 may be provided with a clamping flange 46 (see FIG. 2), a boom support flange 48 and a beam 50. The beam 50 supports the clamping flange 46 and the boom support flange 48 a distance apart in a tire clamping position as shown in FIG. 8, for example for stabilizing the tire clamp 42 onto the top 12 of the tire 14. The beam 50 has a first side 52 and a second side 54 opposite the first side 52. The clamping flange 46 and the boom support flange 48 are positioned on and extend away from the first side 52 of the beam 50 so as to form a tire receiving channel 56 (see FIG. 8) in which the tire 14 is disposed. In one embodiment, at least one of the clamping flange 46 and the boom support flange 48 are movable on the beam 50 generally toward and away from each other (as shown by the arrows in FIG. 8) between the tire clamping position in which the tire clamp 42 is stabilized on the top 12 of the tire 14, and a tire release position in which the tire clamp 42 can be applied to and/or removed from the top 12 of the tire 14.

The wrench support boom 44 may be configured to be removably supported by the tire clamp 42. The wrench support boom 44 is sized and dimensioned to extend from the tire clamp 42 in front of the lug nuts and has a plurality of extension support fingers 58a-h with each of the extension support fingers 58a-h being spatially disposed from the other extension support fingers 58a-h and positionable adjacent to at least one lug nut. In the example shown, the wrench support boom 44 includes eight extension support fingers 58a-h that can be used for tightening between 8-10 lug nuts, for example. However, it should be understood that the wrench support boom 44 may include more or less extension support fingers 58 depending upon the intended application for the torque wrench stabilizer tool 10 and the expected number of lug nuts to be tightened or untightened. In one embodiment, each of the extension support fingers 58a-h is sized and dimensioned to receive and support the wrench extension bar 32 as the torque wrench assembly 24 is being used to tighten and/or untighten at least one of the lug nuts as shown in FIG. 1, for example.

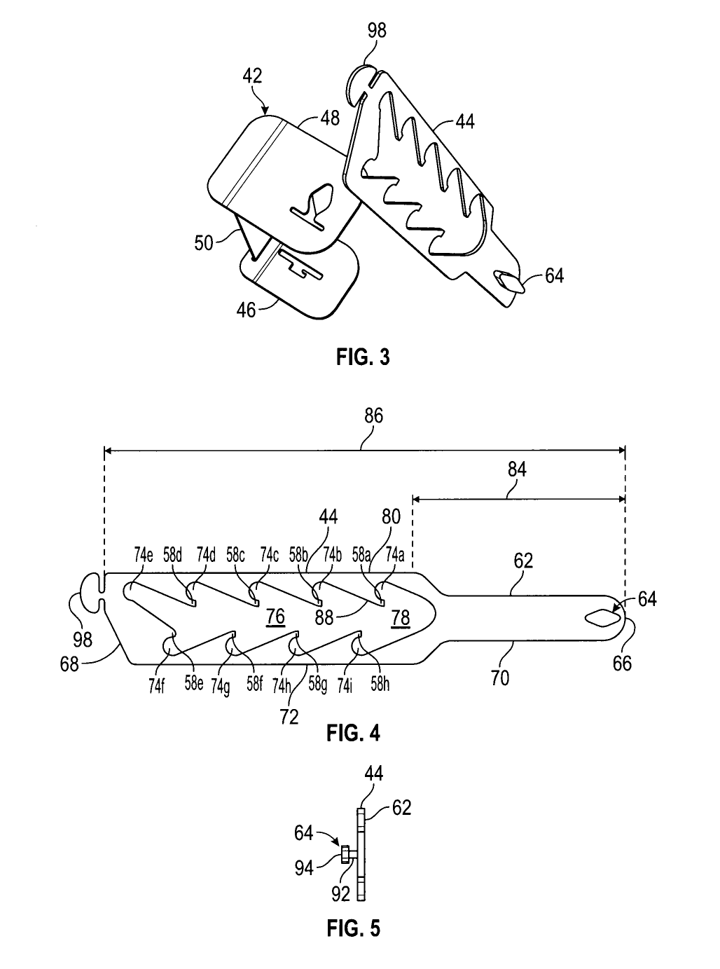

As will be explained below, in one embodiment the tire clamp 42 and the wrench support boom 44 are designed with a variety of predetermined openings and keys so as to selectively interlock into a compact configuration for transport and then be separated for installation into the working configuration on to the tire 14. For example, FIG. 2 shows the torque wrench stabilizer tool 10 positioned in the compact configuration in which the tire clamp 42 and the wrench support boom 44 of the torque wrench stabilizer tool 10 are interlocked and can be easily picked up and transported by a user. FIG. 3 is a perspective view of the torque wrench stabilizer tool 10 in a separated configuration in which the tire clamp 42 and the wrench support boom 44 are not interlocked prior to installation of the torque wrench stabilizer tool 10 into the working configuration (in which the tire clamp 42 and the wrench support boom 44 are connected together) and positioned onto the tire 14 of the vehicle.

Shown in FIG. 4 is a top plan view of the wrench support boom 44. The wrench support boom 44 includes a plate 62 and a first connector portion 64 connected to the plate 62 and extending therefrom. The plate 62 may have a first end 66, and an opposed second end 68. In the example shown, the first connector portion 64 is located on the plate 62 near the first end 66 thereof. The plate 62 has an arm portion 70 extending from the first end 66, and a support portion 72 extending from the arm portion 70 toward the second end 68. The extension support fingers 58a-h are positioned in the support portion 72 of the plate 62. In one embodiment, the support portion 72 of the plate 62 is shaped to form the extension support fingers 58a-h. For example, the support portion 72 can be provided with a plurality of slotted apertures 74a-i bordered at least partially by the extension support fingers 58a-h. Each of the slotted apertures 74a-i is sized and dimensioned to receive the wrench extension bar 32 to permit the extension support fingers 58a-h to support the wrench extension bar 32 during use. In the example shown, the support portion 72 is shaped to include 9 slotted apertures 74a-i, although more or less slotted apertures 74a-i can be provided depending upon the intended application of the wrench support boom 44. In the embodiment shown, the slotted apertures 74a-i are in open communication by way of a central channel 76 and a socket opening 78. In one embodiment, the central channel 76 is sized to permit the wrench extension bar 32 to be moved between the slotted apertures 74a-i; and the socket opening 78 is sized to receive the socket 34. As one skilled in the art will understand, once the socket 34 is positioned through the socket opening 78 and the wrench extension bar 32 is positioned within the central channel 76, the socket 34 may not be removed from the central channel 76 and/or the slotted apertures 74a-i without removing the socket 34 from the wrench extension bar 32, or moving the wrench extension bar 32 into the socket opening 78.

In the embodiment shown, the support portion 72 includes an outer rim 80 that is connected to and supports the extension support fingers 58a-h. The outer rim 80 may also be connected to the arm portion 70.

In the example shown, the wrench support boom 44 is sized for use with a commercial truck tire and wheel. In this example, the arm portion 70 is sized to space the first connector portion 64 a first distance 84 from the extension support fingers 58a-h. The first distance 84 may be fixed, or, alternatively, the arm portion 70 and/or the first connector portion 64 may be configured to permit the first distance 84 to be adjusted. The size of the first distance 84 may vary depending upon the intended application of the wrench support boom 44. The arm portion 70 and the support portion 72 are also sized and dimensioned to permit the wrench support boom 44 to be suspended by the tire clamp 42 in a position above a support surface supporting the tire 14. The arm portion 70 and the support portion 72 may be sized to provide a second distance 86 from the first connector portion 64 to the second end 68. When the wrench support boom 44 is intended to be used for assisting in changing a commercial truck tire and wheel, the first distance 84 can be in a range from about 8 inches to about 12 inches, and the second distance 86 can be in a range from about 20 to 24 inches.

It should be understood that the extension support fingers 58a-h may be provided with a variety of configurations so long as the extension support fingers 58a-h can function to receive and support the wrench extension bar 32. In the example shown, the support portion 72 includes an inner surface 88 in which adjacent extension support fingers 58a-h generally form a J-shape. In this example, the inner surface 88 is shaped to form eight J-shape portions and one I-shaped portion. However, it should be understood that the inner surface 88 can be shaped to form more or less than eight J-shaped portions and more or less I-shaped portions. Further, it should be understood that other configurations and shapes of the inner surface 88 can be used.

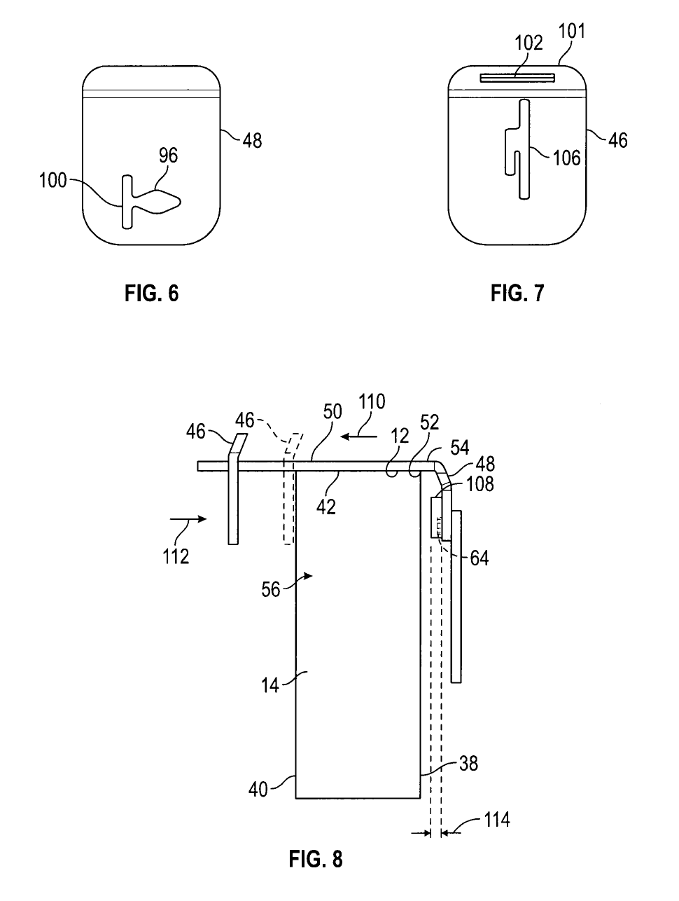

FIG. 5 is an end view of the wrench support boom 44 depicted in FIG. 4. FIG. 6 is a side elevational view of the boom support flange 48 of the torque wrench stabilizer tool 10. The boom support flange 48 has a second connector portion 90 designed to connect with the first connector portion 64 of the wrench support boom 44. In the example shown, the first connector portion 64 has a post 92 and a boom cam 94 although the first connector portion 64 can be constructed in different ways. The post 92 is connected to the arm portion 70 and extends therefrom a distance preferably exceeding a thickness of the boom support flange 48. The second connector portion 90 can be configured as an opening 96 that is sized and shaped to receive the boom cam 94.

Referring again to FIG. 2, the boom support flange 48 may be rigidly connected to (or integrally formed with) the beam 50 so as to prevent inadvertent movement of the boom support flange 48 on the beam 50. The wrench support boom 44 may also be provided with a key 98 connected to and extending from the second end 68. The key 98 functions to connect the second end 68 of the wrench support boom 44 to the boom support flange 48 when the wrench support boom 44 is interconnected with the tire clamp 42. As shown in FIG. 6, the boom support flange 48 may include a keyway 100 adapted to receive the key 98. The key 98 may be provided with a T-shape or an L-shape having a portion that engages against the boom support flange 48 to prevent inadvertent removal of the key 98 from the keyway 100.

FIG. 7 is a side elevational view of the clamping flange 46 of the torque wrench stabilizer tool 10. The clamping flange 46 may be provided with an upper end 101 and a slot 102 in parallel relationship with the upper end 101. The slot 102 may be sized and configured to receive the beam 50 to permit the clamping flange 46 to be selectively moved on the beam 50 either toward or away from the boom support flange 48. The clamping flange 46 may also be provided with a passage 106 shaped to receive the first connector portion 64 and the arm portion 70 when the wrench support boom 44 is interconnected with the tire clamp 42.

Referring now to FIG. 8, shown therein is a front elevational view of the torque wrench stabilizer tool 10 being installed onto the tire 14 in accordance with the present disclosure. In use, the torque wrench stabilizer tool 10 is preferably transported to a jobsite in the compact configuration depicted in FIG. 2 where one or more lug nuts are going to be loosened and/or tightened. The tire clamp 42 and the wrench support boom 44 of the torque wrench stabilizer tool 10 are then separated as depicted in FIG. 3, for example. Then, the tire clamp 42 is placed on the top 12 of the tire 14 such that the beam 50 engages and spans the top 12 and a spacer 108 of the boom support flange 48 is pushed against the front surface 38 of the tire 14 as shown by an arrow 110. In this position, the clamping flange 46 is moved towards the boom support flange 48 until the clamping flange 46 engages the rear surface 40 of the tire 14 as shown by arrow 112. In this position, the tire clamp 42 is stabilized on the top 12 of the tire 14.

In one embodiment, once the tire clamp 42 has been stabilized on the top 12 of the tire 14, the first connector portion 64 of the wrench support boom 44 may be connected (e.g., pivotally connected) to the second connector portion 90 on the boom support flange 48. The spacer 108 (that is connected to and/or a part of the boom support flange 48 may have a thickness 114 sufficient to keep the boom cam 94 from engaging the front surface 38 of the tire 14 thereby assisting the wrench support boom 44 in moving laterally relative to the boom support flange 48. The socket 34 and the wrench extension bar 32 of the torque wrench assembly 24 is then inserted through the socket opening 78, the socket 34 is placed onto one of the lug nuts, and the wrench extension bar 32 is placed into one of the aperture 74a-i and supported on one of the extension support fingers 58a-h. In this position, the torque wrench assembly 28 can then be utilized to tighten and/or loosen the lug nut. After the lug nut is tightened and/or loosened, the socket 34 is placed onto another one of the lug nuts and the wrench extension bar 32 may be positioned into another one of the slotted apertures 74a-i and supported on another one of the extension support fingers 58a-h. This process is then repeated by preferably moving the wrench extension bar 32 through the central channel 76 until all of the lug nuts have either been loosened or tightened. Once all (or less than all) of the lug nuts have either been loosened or tightened, then the socket 34 and the wrench extension bar 32 can be removed from the wrench support boom 44 by way of the socket opening 78, the second connector portion 90 can be disconnected from the first connector portion 64, and the tire clamp 42 can be removed from the top of the tire 14.

The tire clamp 42 and the wrench support boom 44 can be made of any suitably strong and durable material such as metal (e.g., aluminum, steel or the like) or plastic. Further, it should be understood that the tire clamp 42 and/or the wrench support boom 44 can be made of a unitary material or can be formed from separate components that are connected together. Any methodology known in the art for forming material into the components of the tire clamp 42 and/or the wrench support boom 44 can be used such as molding, milling, and combinations thereof.

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

What is claimed is:

1. A torque wrench stabilizer tool for supporting a torque wrench assembly while the torque wrench assembly is being used to engage lug nuts holding a wheel and tire onto a vehicle, the tire having a top, a front surface and a rear surface, the torque wrench stabilizer tool comprising:
a tire clamp positionable on and temporarily connectable to the top of the tire, the tire clamp having a clamping flange, a boom support flange and a beam, the beam supporting the clamping flange and the boom support flange a first distance apart in a tire clamping position, the beam having a first side and a second side opposite the first side, the clamping flange and the boom support flange being positioned on and extending from the first side of the beam; and
a wrench support boom configured to be supported by the tire clamp, the wrench support boom being sized and dimensioned to extend from the tire clamp in front of the lug nuts and having a first extension support finger positionable adjacent to a first lug nut of the lug nuts, and a second extension support finger positionable adjacent to a second lug nut of the lug nuts, the first extension support finger and the second extension support finger being spatially disposed and sized and dimensioned to receive and support the torque wrench assembly.

2. The torque wrench stabilizer tool of claim 1, wherein the clamping flange has a slot receiving the beam such that the clamping flange is selectively movable on the beam in a first direction toward the boom support flange and a second direction away from the boom support flange.

3. The torque wrench stabilizer tool of claim 1, wherein the wrench support boom includes a plate and a first connector portion, the plate having a first end, and an opposed second end and the first connector portion located on the plate near the first end thereof, and wherein the boom support flange includes a second connector portion adapted to connect to the first connector portion.

4. The torque wrench stabilizer tool of claim 1, wherein the wrench support boom includes a plate having a first end, a second opposite the first end, an arm portion extending from the first end, and a support portion extending from the arm portion toward the second end, the first extension support finger and the second extension support finger being positioned in the support portion.

5. The torque wrench stabilizer tool of claim 4, wherein the support portion of the plate is provided with the first extension support finger and the second extension support finger, the support portion of the plate also comprising a first slotted aperture bordered at least partially by the first extension support finger and a second slotted aperture bordered at least partially by the second extension support finger.

6. The torque wrench stabilizer tool of claim 1, wherein the wrench support boom is configured to be pivotally connected to the boom support flange of the tire clamp.

7. The torque wrench stabilizer tool of claim 1, wherein at least one of the clamping flange and the boom support flange are movable on the beam between the tire clamping position and a tire release position.
